(19) United States
(12) Patent Application Publication
(10) Pub. No.: US 2009/0135137 A1
(43) Pub. Date: May 28, 2009

(54) Data Input Method

(76) Inventor: Sergey L' vovich Vostrikov, Moscow (RU)

Correspondence Address: COLLARD & ROE, P.C., 1077 NORTHERN BOULEVARD, ROSLYN, NY, 11576, US

(21) Appl. No.: 12/086,026

(22) PCT Filed: Dec. 1, 2006
(86) PCT No.: PCT/RU2006/000646

§ 371 Date: Jun. 4, 2008

(30) Foreign Application Priority Data
Dec. 20, 2005 (RU) 2005139808

(51) Int. Cl. G09G 5/08

(52) U.S. Cl. 345/157

(57) ABSTRACT

The inventive method relates to information input means and can be used for inputting a wide data spectrum by using a handler. The invention makes it possible to increase the number of the handler displacement modes which are determined for ensuring a data input and correspond to the variants of the inputted information contents. The result is attained by repeatedly carrying out steps consisting in establishment of parameters values origin, in determining the parameter values, in comparing the values with sets of condition for choice of spatial domains from the set thereof comprising at least one condition of belonging of the parameter values corresponding to the handler displacements to the given spatial domain, in recording the sequence of the spatial domain selections, in comparing the record with the determined set of the sequences of the choice of spatial domains and in inputting data linked to the coincident sequence from the set of the data.

### FIELD OF THE INVENTION

The inventive method relates to the means of information input mainly with the use of computers and can be used for inputting a wide data spectrum including symbols, numerals and instructions with the use of a handler (pointing device).

### BACKGROUND OF THE INVENTION

A “Screen Scrolling System” (patent No. EP 0474234) The scroll control system comprises a mouse for inputting cursor displacement data; a cursor shifting section for shifting a cursor in accordance with the cursor displacement data from the mouse; a cursor displacement calculator for calculating the cursor displacement from a central point within a window on the basis of the cursor displacement data and the window central point coordinates; and a scrolling section for scrolling images within the window in a direction and a speed according to cursor direction and distance from the window central point on the basis of the cursor displacement calculated by the cursor displacement calculator. When the cursor is moved by the mouse, scroll is made in linkage with cursor motion. The direction and speed of the scroll are determined on the basis of the direction and distance of the cursor from a central point in a window.

It follows from the given description that the actual result of work of this system is input of the information as the scrolling commands with the scrolling direction and speed parameters. These commands are inputted with the aid of a handler, for example, of a mouse type. These commands are received by the means ensuring information display in the window and use it by executing a certain scrolling mode. The disadvantage of this system is small number of the handler movement types determined for ensuring information input and characterized only by the value and direction of the handler displacement and corresponding variants of the inputted information contents, in the given case—speed of image scrolling in the window.

### SUMMARY OF THE INVENTION

The result of the invention is implementation of the renewable process of data input from the certain data set as a result of making some movements by the handler corresponding to the certain multiple types of such movements. In this case, each type of handler movements is characterized by the sequence of its movements corresponding to one sequence of the set of certain sequences of the multiple certain ranges of value and direction and probably other parameters of handler displacement. At the same time, the data may represent segments of information of any format and volume including: numerals, symbols, instructions, text blocks, raster or vector graphical images, files, data bases. This makes it possible to extend the handler data input capabilities by ensuring practically unlimited increase of the number of the handler movement types determined for ensuring information input by the handler and of the number of the corresponding variants of the inputted information contents.

The invention implementation result is achieved by the method of data input as follows:

prior to inputting the data, the following information is formed in the data input means,

on the set of parameters with some part of them, the absolute parameters, having the origin unchangeable during data input, and includes at least the parameters corresponding to the handler absolute position,

the other part of the relative parameters has the origin of such parameters established during the data input with the use of the absolute parameter values and includes at least the parameters corresponding to handler displacement and having the origin established with the use of the values of the parameters corresponding to the handler absolute position,

on at least one variant of the nonempty set of mutually non-overlapping, simply connected, closed two- or three-dimensional spatial domains of the parameters values corresponding to the handler displacement,

on established correspondence of each ordinal number of the spatial domains selection sequence counts to one of the variants of the spatial domains set,

on nonempty set of the sequences of selection of the spatial domains from the variants of the spatial domains set corresponding to the ordinal numbers of these sequence counts including among the probable sequences at least all sequences not coinciding with each other and with initial parts of each other,

where each sequence establishes correspondence of the elements of the said variants of sets of spatial domains to the ordinal numbers of the sequence counts,

on nonempty set of data where each data element contains the attributes of access to the data corresponding to this data element,

on nonempty set of links of the data set elements with the sequences among the set of spatial domains selection sequences,

on the conditions of selection of spatial domains in the variants of sets of spatial domains with the nonempty set of sets of such conditions established for each spatial domain,

fulfillment of each condition corresponds to belonging of the values of some parameters to the certain domain of such values except for the absolute parameters whose values are used for establishing the origin of relative parameters,

each set of spatial domain selection conditions includes at least the condition of belonging of this spatial domain of the parameters values corresponding to handler displacement,

at least one spatial domain in each variant of the spatial domains set corresponding to any ordinal number of a sequence count of the spatial domains selection sequences has at least one set of its selection conditions not including the irreversibly variable parameters,

on the current ordinal number of the spatial domains selection sequence count corresponding to the initial sequence count,

during data input:

using the parameter determination means the values of those absolute parameters are determined which are used for establishing the origin of the relative parameters including at least the parameters values corresponding to the absolute position of the handler and used for establishing the origin of the parameters corresponding to handler displacement,

after this, the parameters determination means are used for determining the values of parameters from the set of the parameters which are used in the spatial domains selection conditions, and the values of the relative parameters including at least the values of the parameters corresponding to handler displacement are read from their established origin,

the parameters comparison means are used to reveal belonging of the parameters values used in the spatial domains selection conditions to the domains of the parameters values of the said conditions included into the sets of conditions of spatial domains selection from the spatial domains set variant corresponding to the current ordinal number of the spatial domains selection sequence count,

if the parameters values used in the spatial domains selection conditions do not belonging to any set of conditions of any spatial domain selection from the said variant of the set of spatial domains, the above mentioned actions should be repeated beginning with determination of the parameter values,

in case of belonging of the parameters values used in the spatial domains selection conditions to any set of conditions of any spatial domain selection from the said variant of the set of spatial domains, the sequence formation means are used for recording the information fixing correspondence of such selection of the spatial domain to the current ordinal number of the spatial domains selection sequence count,

and the sequences comparison means are used for comparing the record of the information obtained in the order of the numbers beginning with that corresponding to the sequence beginning and corresponding to the sequence count of the spatial domains selection sequence with the sequences of the spatial domains selection sequences set,

in case said information record coincides with one of the sequences set, the data input means are used to obtain the information in compliance with the access attributes contained in the data element linked to this sequence, and this data is inputted,

and the above mentioned actions are repeated beginning with determination of the values of the absolute parameters used for establishing the origin of the relative parameters,

if in this case the said information record coincided with one of the sequences not coinciding with each other and with the initial parts of each other, the value of the current ordinal number of the spatial domains selection sequence count corresponding to the sequence beginning should be established,

otherwise, the value of the spatial domain selection sequence count current ordinal number corresponding to the next ordinal number of the sequence count relative to the last sequence count for which the said information record was executed should be established.

The specific features of the claimed method as compared with the analogous one described above ensuring achievement of the said technical result include the following operations:

showing up belonging of the parameters values used in the conditions of selection of spatial domains to the domains of parameters values of the said conditions included in the sets of conditions for selecting the spatial domains from the spatial domains set variant corresponding to the current ordinal number of the spatial domains selection sequence count,

fulfillment of this operation is an intermediate step in the procedure for determining the handler movement type and is required for determining the fact of correspondence of handler displacement to one of the set of the determined ranges of value, direction and other parameters of handler displacement;

repeating the actions beginning with determination of parameter values executed if the parameters values used in the spatial domain selection conditions do not belong to any spatial domain of the said variant of the spatial domains set,

fulfillment of this operation is an intermediate step in the procedure for determining the handler movement type and is required for ensuring fulfillment of the cyclically renewable previous operation until the said belonging of the parameters values used in the spatial domains from the spatial domains selection conditions is showed up;

recording the information fixing correspondence of the executed selection of the spatial domain to the current ordinal number of the sequence count of the spatial domains selection sequence executed in case of belonging of the parameters values used in the spatial domain selection conditions to any set of conditions of selection of any spatial domain from the said variant of the spatial domains set,

fulfillment of this operation is an intermediate step in the procedure for determining the handler movement type and is required for registering the fact of correspondence of handler displacement to one of the set of the determined ranges of the value, direction and other handler displacement parameters;

comparing the information record corresponding to the spatial domains selection sequence counts and obtained in the order of the numbers beginning with the number corresponding to the sequence beginning with the sequences of the spatial domains selection sequences set,

fulfillment of this operation is an intermediate step in the procedure for determining the handler movement type and is required for determining the fact of coincidence of the executed sequence of one of the set of determined sequences of set of determined ranges of value, direction and other handler displacement parameters;

obtaining the data in compliance with the access attributes contained in the data element linked to this sequence and inputting this information in case of coincidence of the record of the said information with one of the sequences of the set using the data input means,

fulfillment of this operation is required for determining the fact of coincidence of the executed handler displacement with one of the determined handler movement types and at the same time ensures achievement of the main result of the claimed method implementation

input of data from the determined data set, but fulfillment of this operation is insufficient to discontinue determination of the handler movement type,

this operation provides the possibility of multiple data input in the course of the running procedure for determination of the handler movement type in case of sequential coincidence of executed handler displacement with some determined handler movement types characterized by the handler displacement sequences coinciding with each other or with the initial parts of each other;

repeating the actions beginning with determination of the values of the absolute parameters used for establishing the origin of the relative parameters,

fulfillment of this operation is an intermediate step in the procedure for determining the handler movement type and is required for ensuring fulfillment of the cyclically renewable comparison of the executed handler displacement with the determined handler movement types, along with it, fulfillment of this operation ensures the unconditional renewal of the data input process;

establishing the value of the current ordinal number of the spatial domains selection sequence count corresponding to the sequence beginning if, in so doing, the said information record coincided with one of the sequences not coinciding with each other and with the initial parts of each other,

fulfillment of this operation is a completing step of the current handler movement type determination procedure and simultaneously is the first step of such new procedure, at the same time, fulfillment of this operation is a required condition for unceasing renewal of the data input process;

determining the value of the current ordinal number of the spatial domains selection sequence count corresponding to the next ordinal number of the sequence count with respect to the last sequence count for which this information was recorded if the said information record failed to coincide with one of the sequences not coinciding with each other and with the initial parts of each other,

fulfillment of this operation is an intermediate step in the procedure for determining the handler movement type and is a necessary condition of the possibility of comparison of the said information with the information on the determined handler movement types by providing the ordered recording of the information on the sequence of the handler displacements executed.

The data input execution is accompanied by determination of the values of various parameters which form a set of parameters used during data input. Some parameters in this set have the origin of the values of these parameters which does not change during the data input. Such parameters may be defined as absolute parameters since they form within the framework of the means used during data input the absolute, i.e. independent on the information input process, these parameters reference frame.

In so doing, some of these absolute parameters may be used directly during input of data for fulfillment of the respective spatial domains selection conditions. The values of other absolute parameters are used only for establishing the origin of other parameters of the said set. The absolute parameters used for establishing the origin of other parameters include at least those corresponding to the handler absolute position. For example, the parameters of cursor position on the computer display screen may be used as such parameters. Along with the said parameters, the absolute parameters used for establishing the origin of other parameters may include, for example, the computer system time parameter used in this case for establishing the origin time point of the duration of handler displacement. In addition, the absolute parameters may also include those ensuring determination of the handler buttons depressed state, for example, in the form of discrete values corresponding to the buttons depression combination.

Along with the absolute parameters, the set of parameters includes the relative parameters with the origin establishing during data input. Such parameters include, at least, those corresponding to the handler displacement. For establishing the origin of such parameters, use is made of the values of the above mentioned part of the absolute parameters including those corresponding to the absolute position of the handler and used for establishing the origin of the parameters corresponding to handler displacement.

The parameters corresponding to handler displacement may represent the value and direction of the handler displacement from the point corresponding to the coordinate origin.

In so doing, if, for example, a Cartesian coordinate system I used, the said parameters may essentially be a value and a direction of handler displacement along the coordinate axes where direction is determined by the coordinate value differential sign. If the polar coordinate system is used, the handler displacement value is equal to the distance between the coordinate origin and the point corresponding to handler displacement. In this case, the direction is determined, respectively, by one or two angles in two- or three-dimensional system of coordinates between the straight line connecting the coordinate origin with the indicated point and the assigned straight line passing through the coordinate origin.

The given above description of the essence of the invention demonstrates use of mutually non-overlapping, simply connected, closed two- or three-dimensional spatial domains of the values corresponding to the handler displacement. The reference book (G. Corn, T. Corn “Mathematics Reference Book for Scientific Workers and Engineers”, T., 1968, 720 pages, with illustrations, translated from English under the editorship of I. G. Aramanovich, Section 4.3.6) gives the following definitions. Point P is a limit point of a point set S, if each environment of point P contains points of set S other than P. Point P is an internal point of the set S, if P has environment fully contained in S. The limit point P of the set S not being its internal point is a boundary point of the set P. A domain is an open connected set. The union of an open domain and its boundary points is a closed domain. A set is open if it consists of internal points only. A set is the connected one if it cannot be presented in the form of a union of two non-overlapping sets, each of them not containing limit points of the other. A domain D on the Euclidean plane is called a simply connected domain if any simple closed curve fully belonging to D can be tightened in a point with the aid of continuous deformation without leaving domain D.

In accordance with these definitions, sets of mutually no-overlapping, simply connected, closed spatial domains of parameters corresponding to handler displacement are essentially point sets which have only the external boundary and do not have the internal ones. Joint fulfillment of the absence of mutual overlapping, simple connection and closeness of spatial domains condition is required to exclude the ambiguous interpretation of handler displacements in the process of data input. The domains mutual non-overlapping condition means inadmissibility of common points to be available in different domains.

The mentioned spatial domains of the parameters values corresponding to handler displacement should be determined in some, for example, Cartesian or polar space coordinate system for two- and three-dimensional spatial domains. The boundaries of the said spatial domains may be of any shape, for example, constructed from straight sections or circular arcs for two-dimensional spatial domains, limited planes or spherical surfaces for three-dimensional spatial domains.

Availability of several variants of set of spatial domains may promote both, the increase of the number of the handler movement types determined for ensuring data input and the simplification of determination of the spatial domains selection conditions and spatial domains selection sequence links with data elements. Such simplification, for example, is possible in the case, if the variants of the spatial domains set are generated from the same source variant by integration of some neighboring spatial domains.

The spatial domains selection sequence specifies the procedure for enumeration of such domains in which the ordinal number counted from the initial sequence count is put in correspondence to each sequence count. In so doing, the said spatial domains may be affiliated to different sets of the spatial domains, and each sequence establishes correspondence of the elements of the said spatial domains set variants to the ordinal numbers of the spatial domains selection sequence counts. If several variants of spatial domains set are determined, then one of the spatial domains, set variants should be put in correspondence to each ordinal number of the sequence. This means establishment of the respective sequence order for the variants of set of the spatial domains from which the spatial domains are selected.

In the process of the spatial domains selection, execution of each spatial domains selection sequence including more than one sequence count is inevitably accompanied by execution of the number of sequences having fewer sequence counts which copy in these sequence counts the said sequence and are initial parts of this sequence. In this case, if some sequence may be executed, along with this sequence, the possible sequences will include all initial parts of this sequence concomitant to it.

The set of possible sequences includes all principally executable sequences satisfy the condition of admissibility at each step of any spatial domain selection sequence. This set can be represented by two categories of sequences. The first category includes the sequences not coinciding with each other and with the initial parts of each other. The second category includes the sequences which are the initial parts of the sequences of the first category. So, the set of all sequences of the first category induces as their initial parts all, without exception, possible sequences of the second category. Therefore, the sequences falling into the first category may be considered as the boundary elements of the set of possible sequences. Thus, the output for the said boundary of the set of possible sequences is not allowable since it means occurrence of the sequences of selection of the spatial domains coinciding with none of the possible sequences which results in involuntary discontinuation of the data input process.

The data set may include the elements of the main data with their input being the purpose of execution of the input process. In addition, this set may also include the elements of the auxiliary data intended for ensuring execution of the input process. For example, these may be the elements of the data for ensuring indication of the input process execution with the use of audio, visual and other software/hardware equipment for the purpose of providing the feedback with the data input process.

Input of different data becomes possible due to the fact that each data element contains the attributes of access to the data corresponding to this data element. These attributes may determine the source, volume and other information access parameters. For example, used as such attributes may be the range of computer memory addresses in which the data is stored in the form of numerals, symbols, symbol strings. If a large content of data stored, for example, in a file should be brought to conformity to the data element, the name of this file may be used as an attribute.

The said attributes may determine the sources of data varying in the process of data input and representing, for example, program modules. One of the possible sources of such data may be represented by the parameter determining means which makes it possible to bring the parameters values, for example, corresponding to handler displacement to conformity to the data elements.

As it was mentioned above, the set of data may include the auxiliary data elements intended for indicating the input process progress. Such indication may be provided by the use of the data accessible through the attributes of these data after their input. The data input process may be both accompanied and not accompanied by the input progress indication. With no indication accompanying the process the person executing the data input including the operations associated with selection of the spatial domains must do it using his own memory and the psychomotor feelings which accompany the execution of such operations. This variant of data input implementation is similar to the method of “touch-typing” on the keyboard. On the contrary, use of the data input process progress indication with the use of audio, visual and other indication means may be compared, if using the mentioned analogy, with the use of symbol faces on the keyboard keys.

For implementing the data input process, it is possible to use all possible types of data set elements links with the sequences from the set of spatial domains selection sequences, for example, corresponding to the “one-to-one” or “one-to-many” types of relations. It is also permissible that some data set elements or sequences have no relations at all. In this case, it should be noted that absence of the data element relation with any sequence makes its inclusion into the data set senseless.

Fulfillment of each spatial domain selection condition corresponds to belonging of the values of some parameters to the certain domain of such values. This means that the certain domain of parameter values corresponds to each condition. If the said domain contains the values coinciding with the values of the said parameters, this means fulfillment and otherwise—non-fulfillment of the spatial domain selection condition. The parameters used in spatial domains selection conditions may include any parameters of the parameter set except for the absolute parameters whose values are used for establishing the origin of the relative parameters. For this reason, for example, the parameters corresponding to the absolute position of the handler may be used in the spatial domains selection conditions. Along with it, each set of the spatial domain selection conditions should include the condition of belonging of this spatial domain of the parameters values corresponding to handler displacement.

Depending on the nature of the parameters, the values of each parameter in this domain may vary either on the continuous or on the discrete basis. For example, for the condition of belonging of the values corresponding to the handler displacement to some spatial domain which is determined by the analytically assigned boundaries in the coordinate system of continuously varying parameters, the said values in this domain should vary continuously. Also such a situation is possible when the spatial domain is determined by the parameters which assume only the discrete values, for example, this concerns the values of the display screen coordinates corresponding to the position of its pixels. In this case, in principle, also the corresponding method of such domain determination may be used, for example, by enumeration all the values included into this domain.

The examples of parameters are possible which are specific to the domain of continuous values if the forms of presentation of these values on the physical data carrier are not taken into account. Such parameters may include duration of the time intervals and such parameters as the handler displacement speed modulus or its displacement direction change velocity modulus. Along with it, presence of the parameter discrete value area is possible if during the spatial domain selection, the combination of handler buttons pressure is used when some discrete value in the mentioned area of these discrete values may correspond to each such combination.

The possibility of existence of non-empty set of sets of conditions of its selection for each spatial domain ensures the corresponding increase of the number of variants of the spatial domain selection which, in particular, may contribute to reduction of the number of the spatial domains selection errors. In this case, along with the condition of belonging of the values corresponding to handler displacement to the spatial domain and to other conditions, the set of conditions may include the condition establishing the relation of belonging to the respective domain of the parameter value:

duration of the handler displacement from the moment of the handler displacement origin which makes it possible to change the spatial domain selection till the moment when the values of this range are achieved;

the handler displacement speed decrease modulus, i.e. the speed modulus with the handler displacement acceleration negative values which ensures the possibility of the spatial domain selection according to the additional condition of execution of handler deceleration within this domain;

the handler displacement direction change speed modulus, i.e. the handler displacement direction change angular velocity modulus, which provides the possibility of selection of the spatial domain according to the additional condition of the handler displacement trajectory curvature within this domain.

In formation of the sets of conditions, the requirement for availability of at least one of the set of conditions not including the irreversibly varying parameters in at least one spatial domain should be fulfilled. In this case, the irreversibly varying parameters are those whose values cannot be restored by the handler manipulations. The example of the irreversibly varying parameter is duration of the handler displacement. The example of the reversibly varying parameters is the values which correspond to handler displacement and may be restored by the handler displacement, for example, in the reverse direction. Fulfillment of this requirement is necessary for preventing the involuntary discontinuation of the input process caused by the fact that the handler displacement parameter values irreversibly go beyond the boundaries of all parameter value domains corresponding to the conditions of selection of all spatial domains. In this case, there exists at least one domain the selection conditions of which do not contain the ranges of values of the irreversibly variable parameters and the principal possibility of achievement of these parameters ensuring selection of this domain is retained.

The information on the ordinal number of the spatial domains selection sequence count varies in the course of data input and is used for determining the variant of the spatial domains set corresponding to the current ordinal number of the sequence count, as well as for recording the spatial domains selection information corresponding to the spatial domains selection sequence counts. Prior to the data input, the information on the current ordinal number of the spatial domains selection sequence count corresponding to the first sequence beginning should be formed for which the mentioned information will be recorded after the data input begins. As soon as the spatial domain is selected, the mentioned current ordinal number should be changed so that it should correspond to the next ordinal number of the sequence count. In case of termination of recording the information fixing correspondence of the accomplished selection of the spatial domain to the current ordinal number of the spatial domains selection sequence count, the value of the current ordinal number of the spatial domains selection sequence count corresponding to the sequence beginning should be established.

During data input, the parameter values vary due to manipulations made by the handler. In terms of application of the claimed method, the handler is essentially a means generating the signals which serve as a basis for determining the values of the mentioned parameters. That is why the handler is one of the hardware components ensuring determination of the said parameters and formally should be included into the set of the parameter determining means. In the process of data input, the handler is manipulated by its displacement and also, possibly, by pressing of its buttons. In so doing, the handler is displaced following the trajectories ensuring reaching by of the parameter values corresponding to handler displacement relative to the origin point the spatial domain which when selected makes it possible to form the sequence linked to the required data element.

The parameter determination should be effected with a certain time delay after establishing the origin or after the previous determination of parameters to make it possible to manipulate the handler to change the values of these parameters. The means used in data input may include the components ensuring the certain value of such delay. If such components are not available, the mentioned delays will be determined by the processing speed characteristics of the means used for data input.

Establishing of the origin is required for the relative parameters which include at least those corresponding to the handler displacement. The procedure for establishing the origin of the values of each relative parameter executed with the aid of the parameter determination means consists in determination of the values of the absolute parameters used for establishing the origin of this parameter. The moment of determination of the values of these absolute parameters always corresponds to the start of variation of the parameters values corresponding to handler displacement. In so doing, in the data input process, provision should be made at least for determination of the parameters values corresponding to handler displacement. That is why establishing of the origin of these parameters should also be provided by determining the values corresponding to the absolute position of the handler.

As soon as the origin of the relative parameters is established, the parameter values should be determined from the set of parameters which are used in the spatial domains selection sequence count selection conditions. Along with it, the parameter values determined in this case should include at least the values of the parameters corresponding to the handler displacement. The parameter values are determined both directly on the basis of the information arriving from the handler and as a result of additional processing of this information with the use of the parameter determination means.

For example, the information on pressure of the handler buttons characterized by the values of the absolute parameters is used directly. But at the same time, determination of the duration of handler displacement from the origin of the handler displacement requires additional calculations with the use of the information on the current value of time and on the value of time corresponding to the moment of the handler displacement origin. Determination of the values of the decreasing speed modulus and of the handler displacement direction change velocity modulus also requires fulfillment of calculations. In so doing, the mentioned values may be calculated on the basis of the sequentially obtained values corresponding to handler displacement, as well as on the basis of the time synchronously obtained with these values.

Belonging of the parameter values to the ranges of the parameters values included into the spatial domains selection condition sets conditions is revealed as a result of comparison of the values of these parameters with the mentioned parameter value ranges with the aid of parameter comparison means. The spatial domains for which such comparison is executed should belonging to the variant of the spatial domains set corresponding to the current ordinal number of the spatial domains selection sequence recording sequence counts.

The mentioned comparison can be implemented by search of the value in the respective range of values which is precisely the parameter value. For the discretely varying parameter, for example, for the parameter corresponding to the combination of the handler buttons pressure, the comparison may be executed with all values of the respective range of values. For the continuously varying parameters, such comparison can be implemented as a result of calculations including solving of the inequalities and equations constructed with the use of the information on the boundaries of the range of values of these parameters.

The fact of belonging of parameter values to any set of any spatial domain selection conditions is established if the parameter values belong to all ranges of values included into this spatial domain selection conditions included in this set. Establishment of this fact means that selection of the spatial domain is completed and using the sequence formation means the information should be recorded which fixes correspondence of this selection to the current ordinal number of the spatial domain selection sequence count.

Comparison of the executed records of the mentioned information with the set of the spatial domain selection sequences should be executed for revealing their coincidence. Such coincidence means equality of the number of executed records of the information corresponding to the sequence counts of the spatial domain selection sequence beginning with the number corresponding to the sequence beginning to the number of the sequence count of the set of sequences, as well as coincidence of the spatial domains selection for the sequence counts with similar ordinal numbers in these sequences.

In case of coincidence of the mentioned information records with one of the sequences of the set, using the data input means the data element linked to this sequence is inputted if such relation was established before the data input execution. The data input operation includes data obtaining in compliance with the access attributes contained in this data element and transmission of this data to the data input receiver. So, as a result of this operation execution, the possibility of main and auxiliary data input is ensured by means of the mentioned attributes linked to the data of practically any content, format and volume. This, in particular, provides the possibility of the data input also linked by the data used, for example, for signaling completion of spatial domains selection or by the command information, for example, by the data input discontinuation command supplied to the means controlling the start and the end of operation of the means used during data input.

The mentioned data may be transmitted to the data input receiver with the use of the generally known methods providing both target transmission of the data to the specific receiver and broadcasting of this data for all receivers adapted to reception of this information. In the latter case, the data may be transmitted antecedently to the unknown data input receiver. Used as data receivers may be, for example, program modules placed in the computer and ensuring display of this information on the computer display or recording of this information into the file.

Along with the information input, coincidence of this information records with one of the set sequences is also accompanied by renewal of the spatial domains selection process and fulfillment of operations associated with it beginning from determination of the values of the absolute parameters used for establishing the origin of the relative parameters with the aid of the parameter determination means. In this case, coincidence of the said information records with one of the sequences not coinciding with each other and with the initial parts of each other should be accompanied by forced discontinuation of further recording of this information. This is required, as it was mentioned above, for preventing occurrence of the spatial domains selection sequences coinciding with none of the possible sequences. For this purpose, the value of the current ordinal number of the spatial domain selection sequence count is determined which corresponds to the sequence beginning.

If the mentioned information records coincided with the sequence which is an initial part of one of the sequences not coinciding with each other and with the initial parts of each other, recording of the mentioned information should be continued. For this purpose, the value of the current ordinal number of the spatial domains selection sequence count should be established which corresponds to the next ordinal number in this sequence with respect to the last sequence count for which the said information was recorded.

Along with it, a special case may be selected including comparison of the made record of the mentioned information with the set of the spatial domain selection sequences when all sequences of the set of sequences contain only one sequence count. In this case, the said sequences are obligatory belong to the category of sequences not coinciding with each other and with the initial parts of each other. In addition, as a result of this comparison, the value of the current ordinal number of the spatial domain selection sequence count corresponding to the sequence beginning should always be established and the only, a priori known sequence of the set of sequences will correspond to each selection of the spatial domain.

For the set of the one-element sequences, the result of execution of the parameter comparison operation determines selection of some spatial domain inevitably accompanied as its expression by the record of the value corresponding to this selection. In this case, if the set of sequences includes only one sequence, the mentioned value may be a binary one corresponding to either presence or absence of the single spatial domain selection.

Making of the mentioned record may be considered as fulfillment of the operation of recording of the information fixing correspondence of the accomplished spatial domain selection to the one-element spatial domains selection sequence. So, the mentioned record may be considered as a result of joint fulfillment of the parameter comparison operation and of the operation involving recording of the information fixing correspondence of the accomplished spatial domain selection to the one-element spatial domains selection sequence.

In addition, as a result of the above mentioned a priori known correspondence of selection of the spatial domains to the sequences of the set of sequences, the record of the above-mentioned value may be used at the same time for designating the respective one-element sequence. Due to this, provision may also be made for combination of the parameter comparison operation with comparison of the record of the information corresponding to the one-element sequence with the set of sequences.

The shown possibility of combination of operations demonstrates the possibility of respective functional combination of the material objects ensuring fulfillment of these operations in a single object which, in this case, may be defined as means for parameters comparison, formation of sequences and comparison of sequences.

### DESCRIPTION OF THE DRAWINGS

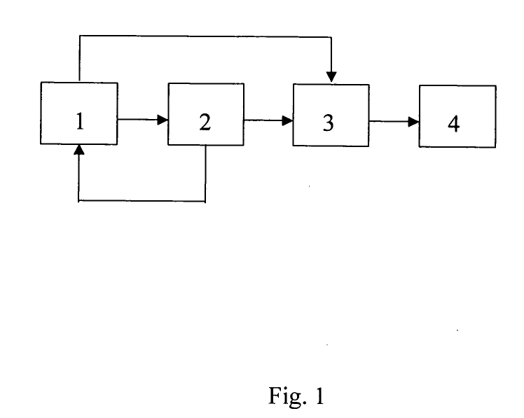

Use of the claimed method is illustrated on the example of method implementation in the device for inputting data on the direction and distance of displacement of the handler shown in FIG. 1.

### EMBODIMENT OF INVENTION

In the claimed method:

the coordinates of the cursor on the display screen are used as the parameters corresponding to the handler absolute position whereas the handler displacement direction and distance are used as the relative parameters corresponding to handler displacement;

a single set of spatial domains is formed which includes a single two-dimensional spatial domain covering the entire plane except for the circular domain with its center arranged at the origin of coordinates and determining the circular boundary of this spatial domain of some radius;

used as the condition for selection of this spatial domain is the condition of belonging of the values corresponding to handler displacement to it;

a set of spatial domain selection sequences is formed which includes a one-element sequence;

a set of data is formed which contains one data element with its data access attribute represented by the data source which is essentially the parameters determining means and contains the values corresponding to the direction and distance of cursor displacement;

a set of links is formed which includes a single link between the said single data element and the single sequence.

The handler displacement direction and distance data input device (ref. FIG. 1) is built around the software/hardware components of the general-purpose computer. These components include:

computation processor with the basic input-output system (BIOS);

memory for information storage;

display;

keyboard which is not used in the handler displacement direction and distance data input device (ref. FIG. 1) but is required for normal operation of the computer;

handler (pointing device);

controllers and drivers of computer components;

interfaces for information exchange between the computer components;

multi-task operation system ensuring management of such information exchange and operation of the computer components and programs installed on the computer.

The mentioned multi-task operation system ensures sharing of computing resources, memory and other software/hardware components of the computer among the set of concurrently executed computing processes and implemented functions. This also concerns to the functions of data input with the aid of a keyboard and of a handler, information presentation on the display screen and also cursor movements on the display screen in the display screen coordinates corresponding to the handler displacement. In this connection, the computer may be considered as a multifunctional device emulating parallel operation of the set of specialized software/hardware functional units. In so doing, the mentioned computer hardware components are used as a part of these software/hardware functional units. The block diagram of the handler displacement direction and distance data input device (ref. FIG. 1) explaining the essence of the claimed invention demonstrates the following specialized software/hardware functional units with their operation emulated by the mentioned computer:

means 1 for parameters determination;

means 2 for parameters comparison, formation of sequences and comparison of sequences in which coincidence of functions of the parameter comparison means, sequence formation means and sequence comparison means is attained as mentioned above by including a single one-element sequence into the set of sequences;

data input means 3;

data input receiver 4.

Specialization of the computer hardware components in the listed software/hardware functional units, as well as the information interaction of these units in compliance with the essence of the claimed invention is provided by the use of the software components in these units which ensure implementation of their functions. In this case, operation of the said software components, as well as transmission of information between the functional units is always ensured by the use of a computation processor. Each software/hardware functional unit employs the following computer components:

memory for recording, storing and reading the information required for operation of this unit and, probably, of the software ensuring functional specialization of the unit, containing the required information used during data input and the data input;

computation processor;

interfaces for information exchange between the mentioned devices;

operation system ensuring management of operation of the said computer components and software.

Along with the listed components, parameter determination means 1 also employ a handler and a display with their controllers and drivers.

Memory in the software/functional units is used as follows:

in means 1 for parameters determination—for recording, storing and reading the parameter values, for installing the parameter values determination program, for activating means 2 for parameters comparison, formation the sequence and comparison of sequences and for transferring the parameter values to them;

in means 2 for parameters comparison, formation of sequences and comparison of Sequences—for recording, storing and reading the parameter values, as well as for installing the parameters comparison program, formation the sequence, for comparing the sequences and for activating data input means 3 and means 1 for parameters determination;

in data input means 3—for recording, storing and reading the parameters, as well as for installing the program ensuring receipt of the information from means 1 for parameters determination, for activating data input receiver 4 and transmitting this information to it;

in data input receiver 4—for recording the inputted information and for installing the program for recording the inputted data in compliance with the certain format.

Then follows the description of operation of this device at the system-wide level of joint functioning of means 1 to 4 incorporated in this device, as well as at the intersystem level of functioning of each of the mentioned means. Description of the device operation at the system-wide level demonstrates fulfillment of operations with material objects represented as the mentioned means. Description of functioning of each of the mentioned means concerns the possible variant of the software-algorithmic implementation of processing of the information required for executing the operations with the aid of these means.

So, at the system-wide level, parameters determination means 1 allow two variants of their activation: with and without establishing of the origin of the parameters corresponding to handler displacement. The variant of activation of parameters determination means 1 with establishing the origin of the parameters corresponding to handler displacement is implemented after beginning of operation of the device for inputting the data on handler displacement direction and distance (ref. FIG. 1) or from means 2 for parameters comparison, formation of sequences and comparison of sequences in case a single domain is selected. The variant of activation of parameters determination means 1 without establishing the origin of the parameters corresponding to handler displacement is implemented in case of their activation from means 2 for parameters comparison, formation of sequences and comparison of sequences if the mentioned spatial domain was not selected.

In case of activation of parameters determination means 1 in the variant with establishing the origin of the parameters corresponding to handler displacement, display of the cursor coordinate values on the screen should be provided. These coordinate values should be taken as the origin for handler displacement. After this, parameters determination means 1 ensure the repeated obtaining of the cursor coordinate values on the screen. Then, parameters determination means 1 using these values and the values assumed as the starting point for handler displacement reading calculate the values corresponding to the direction and distance of handler displacement relative to the coordinates assumed as a starting point for reading cursor displacement. Then parameters determination means 1 activate means 2 for parameters comparison, formation of sequences and comparison of sequences and transfer to them the obtained value, corresponding handler displacement distances. Parameters determination means 1 when activated in the variant without establishing the origin of parameters values corresponding to the handler displacement fulfill the above-mentioned operations beginning with the repeated obtaining of the coordinate values on the display screen.

Means 2 for parameters comparison, formation of sequences and comparison of sequences when activated from parameters determination means 1 compare the value received from parameters determination means 1 corresponding to the handler displacement distance with the value of the radius of the spatial domain circular boundary. If the value corresponding to the handler displacement distance is less than the radius of the spatial domain circular boundary, this value does not belong to the spatial domain. In this case, means 2 for parameters comparison, formation of sequences and comparison of sequences activate parameters determination means 1 in the activation version without establishing the origin of the parameters corresponding to handler displacement. If the value corresponding to the handler displacement distance exceeds the radius of the spatial domain circular boundary, this value belongs to the spatial domain. In this case, means 2 for parameters comparison, formation of sequences and comparison of sequences activate parameters determination means 1 in the version with establishing the origin of the parameters corresponding to handler displacement and activate data input means 3. Data input means 3 when activated from means 2 for parameters comparison, formation of sequences and comparison of sequences receive from parameters determination means 1 the values corresponding to the handler displacement direction and distance, activate data input receiver 4 and transfer the received values to it.

Data input receiver 4 when activated from data input means 3 records the received data into its own memory in accordance with a certain format.

At the intersystem level of parameters determination means 1 in the version of their activation with establishing the origin of the parameters corresponding to handler displacement, the program for parameter values determination, activating means 2 (for parameters comparison, formation of sequences and comparison of sequences, transferring the parameter values to them) receives messages from the operation system on handler displacements. These messages contain the information on the values of the handler coordinates on the display screen corresponding to the handler position. The received values of coordinates are recorded into the memory by this program. These coordinate values are the origin of the values corresponding to handler displacement.

Then this program repeatedly receives from the operation system the messages on handler displacement containing the information on values of cursor coordinates on the display screen corresponding to the handler position which are recorded by this program into the memory. After this, the program reads from the memory the values of coordinates which are the origin of the values corresponding to the handler displacement and the repeatedly received coordinate values and based on these values calculates the tilt angle and length of the straight line section connecting two points with the said coordinates, after which record these values into the memory. The mentioned values correspond to handler displacement direction and distance. Then, this program activates means 2 for parameters comparison, formation of sequences and comparison of sequences, reads from the memory the value corresponding to the handler displacement distance and sends this value to the said means. Then the program is changed over to the waiting state for activation of parameters determination means 1. In the variant of parameters determination means 1, activation without establishing the origin of the parameters corresponding to handler displacement, this program fulfills the above-mentioned operations beginning with repeated receipt of messages from the operation system about handler displacement.

At the intersystem level of means 2 for parameters comparison, formation of sequences and comparison of sequences, after their activation, the program for parameters comparison, formation the sequence, comparing the sequences, activating data input means 3 and means 1 for parameters determination receives and records into the memory the said value corresponding to the handler displacement distance. In this case, the mentioned program already contains the built-in information with the value of the spatial domain circular boundary radius. Then this program reads from the memory and compares the value corresponding to handler displacement distance with the radius of the spatial domain circular boundary and fixes the fact of excess of one of the said values over the other by recording into the memory the respective binary value. As it was mentioned above, the said record at the same time:

reflects selection of the spatial domain;

is essentially the record of the information fixing correspondence of selection of the spatial domain to the one-element sequence of spatial domains selection;

is the result of comparison of this information record with the set of sequences including the single one-element sequence.

Since the set of sequences includes the single one-element sequence, occurrence of the value in the mentioned record corresponding to coincidence with this sequence requires establishing of the value of the current ordinal number of the spatial domain selection sequence count corresponding to the sequence beginning. That is why in the device for inputting the data on handler displacement direction and distance (ref. FIG. 1), the value of the current ordinal number of the spatial domain selection sequence count always corresponds to the sequence beginning.

Then, depending on the said binary value read by the program from the memory, this program fulfils one of two variants of activation of parameters determination means 1. In this case, if parameters determination means 1 are activated in the variant with establishing the origin of the parameters corresponding to handler displacement, data input means 3 are also activated. Then the program is changed over to the waiting state for activation of means 2 for parameters comparison, formation of sequences and comparison of sequences. In this case, it can be noted that within the framework of joint means 2 for parameters comparison, formation of sequences and comparison of sequences and comparison of sequences of activation of parameters determination means 1 in the variant without establishing the origin of parameters values corresponding to the handler displacement belonging to the functions of parameter comparison means. Along with it, the variant of activation of parameters determination means 1 with the variant with establishing the origin of the parameters corresponding to handler displacement with concurrent activation of data input means 3 belonging to the functions of the sequence comparison means.

At the intersystem level of data input means 3, after their activation, the program for receiving information from means 1 for parameters determination, activation of data input receiver 4 and transmission of this information to it implements the link formed in this program between the said single one-element sequence and the only data. The data are implemented in this program as a program module containing the attributes of the source of data on handler displacement direction and distance which is essentially the area of memory of parameters determination means 1. The said link is implemented in the program due to establishing of the reference to the attributes of these data which is implemented by the program. In accordance with the said attributes, this program reads the values corresponding to the direction and distance of handler displacement from the memory belonging to parameters determination means 1 and records this information into its own memory. Then this program activates data input receiver 4, reads the value corresponding to the handler displacement direction and distance from its own memory and transmits these values to data input receiver 4.

At the intersystem level of data input receiver 4, after its activation, the program for recording the inputted data in compliance with the certain format records the values corresponding to the handler displacement direction and distance into the memory of data input receiver 4.

1. Method of data input in which prior to inputting the data, the following information is formed in the data input means,
on the set of parameters with some part of them, the absolute parameters, having the origin unchangeable during data input, and includes at least the parameters corresponding to the handler absolute position,
the other part of the relative parameters has the origin of such parameters established during the data input with the use of the absolute parameter values and includes at least the parameters corresponding to handler displacement and having the origin established with the use of the values of the parameters corresponding to the handler absolute position,
on at least one variant of the nonempty set of mutually non-overlapping, simply connected, closed two- or three-dimensional spatial domains of the parameters values corresponding to the handler displacement,
on established correspondence of each ordinal number of the spatial domains selection sequence counts to one of the variants of the spatial domains set,
on nonempty set of the sequences of selection of the spatial domains from the variants of the spatial domains set corresponding to the ordinal numbers of these sequence counts including among the probable sequences at least all sequences not coinciding with each other and with initial parts of each other,
where each sequence establishes correspondence of the elements of the said variants of sets of spatial domains to the ordinal numbers of the sequence counts,
on nonempty set of data where each data element contains the attributes of access to the data corresponding to this data element,
on nonempty set of links of the data set elements with the sequences among the set of spatial domains selection sequences,
on the conditions of selection of spatial domains in the variants of sets of spatial domains with the nonempty set of sets of such conditions established for each spatial domain,
fulfillment of each condition corresponds to belonging of the values of some parameters to the certain domain of such values except for the absolute parameters whose values are used for establishing the origin of relative parameters,
each set of spatial domain selection conditions includes at least the condition of belonging of this spatial domain of the parameters values corresponding to handler displacement,
at least one spatial domain in each variant of the spatial domains set corresponding to any ordinal number of a sequence count of the spatial domains selection sequences has at least one set of its selection conditions not including the irreversibly variable parameters,
on the current ordinal number of the spatial domains selection sequence count corresponding to the initial sequence count, during data input:
using the parameter determination means the values of those absolute parameters are determined which are used for establishing the origin of the relative parameters including at least the parameters values corresponding to the absolute position of the handler and used for establishing the origin of the parameters corresponding to handler displacement,
after this, the parameters determination means are used for determining the values of parameters from the set of the parameters which are used in the spatial domains selection conditions, and the values of the relative parameters including at least the values of the parameters corresponding to handler displacement are read from their established origin,
the parameters comparison means are used to reveal belonging of the parameters values used in the spatial domains selection conditions to the domains of the parameters values of the said conditions included into the sets of conditions of spatial domains selection from the spatial domains set variant corresponding to the current ordinal number of the spatial domains selection sequence count,
if the parameters values used in the spatial domains selection conditions do not belonging to any set of conditions of any spatial domain selection from the said variant of the set of spatial domains, the above mentioned actions should be repeated beginning with determination of the parameter values,
in case of belonging of the parameters values used in the spatial domains selection conditions to any set of conditions of any spatial domain selection from the said variant of the set of spatial domains, the sequence formation means are used for recording the information fixing correspondence of such selection of the spatial domain to the current ordinal number of the spatial domains selection sequence count,
and the sequences comparison means are used for comparing the record of the information obtained in the order of the numbers beginning with that corresponding to the sequence beginning and corresponding to the sequence count of the spatial domains selection sequence with the sequences of the spatial domains selection sequences set,
in case said information record coincides with one of the sequences set, the data input means are used to obtain the information in compliance with the access attributes contained in the data element linked to this sequence, and this data is inputted,
and the above mentioned actions are repeated beginning with determination of the values of the absolute parameters used for establishing the origin of the relative parameters,
if in this case the said information record coincided with one of the sequences not coinciding with each other and with the initial parts of each other, the value of the current ordinal number of the spatial domains selection sequence count corresponding to the sequence beginning should be established,
otherwise, the value of the spatial domain selection sequence count current ordinal number corresponding to the next ordinal number of the sequence count relative to the last sequence count for which the said information record was executed should be established.
